(19) United States
(12) Patent Application Publication
(10) Pub. No.: US 2018/0083972 A1
(43) Pub. Date: Mar. 22, 2018

(54) METHOD AND APPARATUS FOR SECURITY CONFIGURATION IN WIRELESS COMMUNICATION SYSTEM

(71) Applicant: LG ELECTRONICS INC., Seoul (KR)

(72) Inventor: Joonwoong KIM, Seoul (KR)

(73) Assignee: LG ELECTRONICS INC., Seoul (KR)

(21) Appl. No.: 15/614,085

(22) Filed: Jun. 5, 2017

Related U.S. Application Data
(60) Provisional application No. 62/396,831, filed on Sep. 20, 2016.

(51) Int. Cl. H04L 29/06

(52) U.S. Cl. CPC H04L 63/10; H04L 63/205; H04L 41/0803; H04L 63/065; H04L 63/0428; H04L 63/08

(57) ABSTRACT

Disclosed is a method for a security configuration in a wireless communication system and an apparatus using the same. Specifically, in a method for performing a security configuration by a UE (User Equipment), the method may comprise steps of transmitting a security capability of the UE to a network, receiving security information determined by the network from the network, and determining an action of the UE, based on a configuration of a security control configured in the UE and the security information received from the network, and the configuration of the security control may includes a security capability item, a control condition of the security capability item, and the action of the UE in accordance with the control condition.

### CROSS-REFERENCE TO RELATED APPLICATIONS

Pursuant to 35 U.S.C. § 119(e), this application claims the benefit of U.S. Provisional Patent Application No. 62/396,831, filed Sep. 20, 2016, the contents of which are hereby incorporated by reference herein in its entirety.

### BACKGROUND OF THE INVENTION

### Field of the Invention

The present invention relates to a wireless communication system, and relates to a method and an apparatus for providing/displaying or controlling/configuring a security capability or level of system or service.

### Related Art

A mobile communication system has been developed to provide a voice service while guaranteeing user mobility. However, the mobile communication system has been extended to a service range to a data service as well as a voice service, and nowadays, a resource shortage phenomenon occurs due to explosive traffic increase and users request a higher speed service and thus a more enhanced mobile communication system is required.

A next generation mobile communication system should be able to support acceptance of explosive data traffic, epochal increase of a transmission rate per user, acceptance of the largely increased connection devices number, very low end-to-end latency, and high energy efficiency. For this reason, various technologies such as dual connectivity, Massive Multiple Input Multiple Output (Massive MIMO), In-band Full Duplex, Non-Orthogonal Multiple Access (NOMA), super wideband support, and device networking have been researched.

### SUMMARY OF THE INVENTION

The present invention proposes a method of providing/displaying a user or a user equipment (UE) with a security capability or level of system or service.

Further, the present invention proposes a method for controlling/configuring the security capability or level of system or service by a user or a UE.

The technical problems of the present invention are not limited to the above-described technical problems and the other technical problems will be understood by those skilled in the art from the following description.

An aspect of the present invention, in a method for performing a security configuration by a UE (User Equipment) in a wireless communication system, the method comprises steps of transmitting a security capability of the UE to a network, receiving security information determined by the network from the network, and determining an action of the UE, based on a configuration of a security control configured in the UE and the security information received from the network, and the configuration of the security control may include a security capability item, a control condition of the security capability item, and the action of the UE in accordance with the control condition.

Another aspect of the present invention, in a UE (User Equipment) for performing a security configuration in a wireless communication system, the UE comprises a radio frequency (RF) unit for transmitting and receiving a wireless signal, and a processor for controlling the RF unit, and the processor is configured to transmit a security capability of the UE to a network, receive security information determined by the network from the network, and determine an action of the UE, based on a configuration of a security control configured in the UE and the security information received from the network, and the configuration of the security control includes a security capability item, a control condition of the security capability item, and the action of the UE in accordance with the control condition.

Preferably, the security capability item may include an authentication method, an encryption algorithm, and an integrity algorithm.

Preferably, if the control condition indicates (or show, represent) one or more values of the security capability item, when the security information indicates the one or more values of the security capability item, the action of the UE may be performed.

Preferably, if the control condition indicates a change of value of the security capability item, and when a value of the security capability item applied to communication between the UE and the network is changed depending on a value indicated by the security information, the action of the UE may be performed.

Preferably, the action may include an action of accepting the security information received from the network, an action of retransmitting the security capability of the UE to the network, and an action of disconnecting a connection with the network.

Preferably, the configuration of the security control may be provisioned to the UE by the network, and/or is configured to the UE based on one or more among an input from a user, a requirement of application and application/service.

Preferably, when the configuration of the security control of the network is provisioned to the UE by the network, and the configuration of the security control of the user is configured by the UE, a configuration of the security control with a high priority may be configured by the UE, among the configuration of the security control of the network and the configuration of the security control of the user.

Preferably, whether the security information received from the network is notified of the user, may be determined based on the configuration of the security indication configured in the UE and the security information received from the network, and the configuration of the security indication may include an security capability item, an indication condition of the security capability item.

Preferably, if the indication condition indicates one or more values of the security capability item, when the security information indicates the one or more values of the security capability item, the notification may be performed.

Preferably, if the indication condition indicates a change of the value of the security capability item configured by the configuration of the security control, and when a value of the security capability item applied to communication between the UE and the network is changed depending on a value indicated by the security information, the notification may be performed.

Preferably, the notification may be displayed in a top of a screen of the UE, displayed until an explicit confirmation is inputted from a user, or displayed during a predetermined time.

According to an embodiment of the present invention, a difference may be prevented from being occurred between a security capability or level expected by a user or application and a security capability or level provided from a network.

According to an embodiment of the present invention, a weak level of security algorithm/method which is not expected by a user may be prevented from being applied to a UE.

The effect of the present invention is not limited to the above-described effects and the other objects will be understood by those skilled in the art from the following description.

### BRIEF DESCRIPTION OF THE DRAWINGS

For understanding of the present invention, the attached drawings included as a portion of a detailed description provide an exemplary embodiment of the present invention and describe a technical characteristic of the present invention together with a detailed description.

FIG. 1 illustrates an Evolved Packet System (EPS) to which the present invention can be applied.

FIG. 2 illustrates an example of a structure of an evolved universal terrestrial radio access network (E-UTRAN) to which the present invention can be applied.

FIG. 3 illustrates a structure of an E-UTRAN and an EPC in a wireless communication system to which the present invention can be applied.

FIG. 4 illustrates a radio interface protocol structure between a UE and an E-UTRAN in a wireless communication system to which the present invention can be applied.

FIG. 5 illustrates a structure of a physical channel in a wireless communication system to which the present invention can be applied.

FIG. 6 illustrates a contention-based random access procedure in a wireless communication system to which the present invention can be applied.

FIG. 7 illustrates a NAS security mode command procedure in a wireless communication system to which the present invention can be applied.

FIG. 8 illustrates a AS security mode command procedure in a wireless communication system to which the present invention can be applied.

FIG. 9 is a diagram of illustrating a method of indicating and/or controlling a security in accordance with an embodiment of the present invention.

FIG. 10 illustrates a procedure for a UE security indication and control in accordance with an embodiment of the present invention.

FIG. 11 illustrates a diagram of illustrating of an operation of UE for a UE security configuration in accordance with an embodiment of the present invention.

FIG. 12 is a block diagram illustrating a configuration of a communication device according to an exemplary embodiment of the present invention.

FIG. 13 is a block diagram illustrating a configuration of a communication device according to an exemplary embodiment of the present invention.

### DESCRIPTION OF EXEMPLARY EMBODIMENTS

Hereinafter, an exemplary embodiment of the present invention will be described in detail with reference to the attached drawings. A detailed description of the present invention to be described hereinafter together with the attached drawings describes an exemplary embodiment of the present invention and does not represent a sole embodiment in which the present invention may be executed. The following detailed description includes detailed contents in order to provide complete understanding of the present invention. However, a person of ordinary skill in the art knows that the present invention may be executed without such detailed contents.

In several cases, in order to avoid a concept of the present invention from being ambiguous, well-known structures and devices may be omitted or a core function of each structure and device may be mainly shown in a block diagram form.

In this specification, a base station has a meaning as a terminal node of a network that directly communicates with a terminal. In this document, a specific operation described as performed by a base station may be performed by an upper node of the base station in some case. That is, in a network configured with a plurality of network nodes including the base station, it will become apparent that various operations performed for communication with the terminal may be performed by a base station or other network nodes other than the base station. A Base Station (BS) may be replaced with a term such as a fixed station, a Node B, an evolved-NodeB (eNB), a base transceiver system (BTS), and an Access Point (AP). Further, the ‘terminal’ may be fixed or may have mobility and may be replaced with a term such as a User Equipment (UE), a Mobile Station (MS), a User terminal (UT), a Mobile Subscriber Station (MSS), a Subscriber Station (SS), an Advanced Mobile Station (AMS), a Wireless terminal (WT), a Machine-Type Communication (MTC) device, a Machine-to-Machine (M2M) device, and a Device-to-Device (D2D) device.

Hereinafter, a downlink (DL) means communication from the BS to the terminal, and an uplink (UL) means communication from the terminal to the base station. In the downlink, a transmitter may be a portion of the base station, and the receiver may be a portion of the terminal. In the uplink, the transmitter may be a portion of the terminal, and the receiver may be a portion of the base station.

Specific terms used in the following description are provided for understanding of the present invention, and use of such a specific term may be changed in other forms without deviating from the spirit and scope of the present invention.

The following technology may be used for various wireless access systems such as code division multiple access (CDMA), frequency division multiple access (FDMA), time division multiple access (TDMA), orthogonal frequency division multiple access (OFDMA), single carrier frequency division multiple access (SC-FDMA), and non-orthogonal multiple access (NOMA). The CDMA may be implemented with radio technology such as universal terrestrial radio access (UTRA) or CDMA2000. The TDMA may be implemented with radio technology such as global system for mobile communications (GSM)/general packet radio service (GPRS)/enhanced data rates for GSM evolution (EDGE). The OFDMA may be implemented with radio technology such as IEEE 802.11 (Wi-Fi), IEEE 802.16 (WiMAX), IEEE 802-20, and E-UTRA (evolved UTRA). The UTRA is a portion of a universal mobile telecommunications system (UMTS). 3rd generation partnership project (3GPP) long term evolution (LTE) is a portion of an evolved UMTS (E-UMTS) using E-UTRA and adapts OFDMA in a downlink and adapts SC-FDMA in an uplink. LTE-advanced (A) is innovation of 3GPP LTE.

Exemplary embodiments of the present invention may be supported by standard documents that describe at least one of IEEE 802, 3GPP, and 3GPP2, which are wireless access systems. That is, in exemplary embodiments of the present invention, steps or portions that are not described to clearly expose the spirit and scope of the present invention may be supported by the documents. Further, entire terms of this document may be described by the standard document.

For clear description, 3GPP LTE/LTE-A is mainly described, but a technical characteristic of the present invention is not limited thereto.

Terms that may be used in this document are defined as follows.
Universal Mobile Telecommunications System (UMTS): 3-Generation mobile communication technology based on Global System for Mobile Communication (GSM) and developed by 3GPP,
Evolved Packet System (EPS): A network system configured with an Evolved Packet Core (EPC), which is a packet switched core network based on an Internet Protocol (IP) and an access network such as LTE and UTRAN. The EPS is a network of a form in which the UMTS is innovated.
NodeB: Base station of an UMTS network. The NodeB is installed outdoor and covers a macro cell.
eNodeB: Base station of an EPS network. The eNodeB is installed outdoor and covers a macro cell.
UE: User device. The UE may be referred to as a term such as a terminal, a Mobile Equipment (ME), and a Mobile Station (MS). Further, the UE may be a device that can carry such as a notebook computer, a mobile phone, a Personal Digital Assistant (PDA), a smart phone, and a multimedia device or may be a device that cannot carry such as a Personal Computer (PC) and a vehicle mounting device. In MTC related contents, the UE may indicate an MTC terminal.
IP Multimedia Subsystem (IMS): Subsystem that provides a multimedia service based on IP.
International Mobile Subscriber Identity (IMSI): Internationally uniquely allocated user identifier in a mobile communication network.
Public Land Mobile Network (PLMN): A network configured as an object to provide a mobile communication service to individuals. The PLMN may be divided and configured on an operator basis.
Non-Access Stratum (NAS): A functional layer for transmitting and receiving a traffic message and signaling between a terminal and a core network at UMTS and EPS protocol stacks. The NAS has a main function of supporting mobility of the terminal and supporting a session management procedure that establishes and maintains IP connection between the terminal and a PDN GW.

Hereinafter, the present invention will be described based on the defined terms.

System to which the Present Invention can be Applied

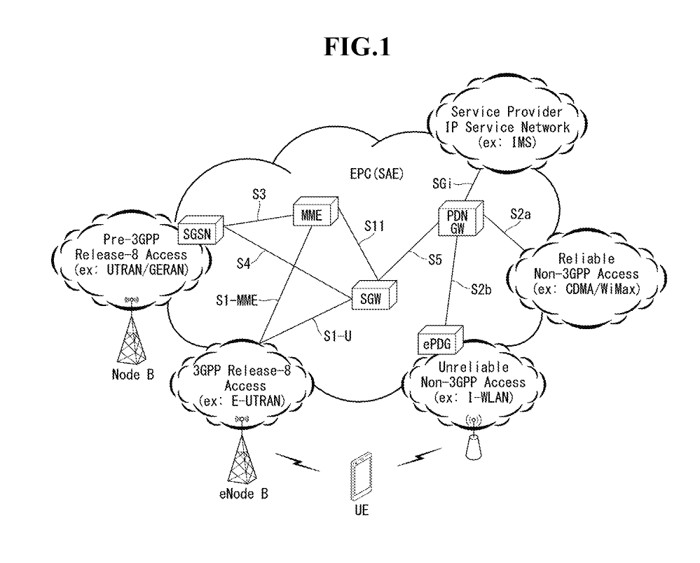

FIG. 1 illustrates an Evolved Packet System (EPS) to which the present invention can be applied.

A network structure diagram of FIG. 1 simply illustrates a structure of an EPS including an Evolved Packet Core (EPC).

An EPC is a core element of System Architecture Evolution (SAE) for enhancing a performance of 3GPP technologies. The SAE corresponds to a research subject that determines a network structure that supports mobility between various kinds of networks. The SAE has a target that provides an optimized packet-based system that supports various wireless access technologies based on, for example, an IP and that provides a more enhanced data transmission ability.

Specifically, the EPC is a core network of an IP mobile communication system for a 3GPP LTE system and may support a packet-based real time and non-real time service. In an existing mobile communication system (i.e., second generation or third generation mobile communication system), a function of a core network was implemented through two distinguished sub-domains of Circuit-Switched (CS) for voice and Packet-Switched (PS) for data. However, in an innovated 3GPP LTE system of the third generation mobile communication system, sub-domains of CS and PS were unified into a single IP domain. That is, in the 3GPP LTE system, connection between terminals having an IP capability may be formed through an IP-based base station (e.g., evolved Node B (eNodeB)), an EPC, an application domain (e.g., IMS). That is, the EPC is an essential structure in implementing an end-to-end IP service.

The EPC may include various constituent elements, and FIG. 1 illustrates a Serving Gateway (SGW) (or S-GW), a Packet Data Network Gateway (PDN GW) (or PGW or P-GW), a Mobility Management Entity (MME), a Serving General Packet Radio Service (GPRS) Supporting Node (SGSN), and an enhanced Packet Data Gateway (ePDG) corresponding to a portion of the various constituent elements.

The SGW operates as a boundary point between a radio access network (RAN) and a core network and is an element that performs a function of maintaining a data path between the eNodeB and the PDN GW. Further, when the terminal moves over an area served by the eNodeB, the SGW performs a function of a local mobility anchor point. That is, for mobility within a Universal Mobile Telecommunications System (Evolved-UMTS) Terrestrial Radio Access Network defined after 3GPP release-8) (E-UTRAN), packets may be routed through the SGW. Further, the SGW may function as an anchor point for mobility with another 3GPP network (RAN defined before 3GPP release-8, for example, UTRAN or Global System for Mobile Communication (GSM)/Enhanced Data rates for Global Evolution (EDGE) Radio Access Network (GERAN)).

The PDN GW corresponds to a termination point of a data interface toward a packet data network. The PDN GW may support policy enforcement features, packet filtering, and charging support. Further, the PDN GW may perform an anchor point function for mobility management with an unreliable network such as a 3GPP network and a non-3GPP network (e.g., an Interworking Wireless Local Area Network (I-WLAN), a Code Division Multiple Access (CDMA) network or a reliable network such as a Wimax).

In an illustration of a network structure of FIG. 1, the SGW and the PDN GW are configured as a separate gateway, but two gateways may be implemented according to a single gateway configuration option.

The MME is an element that performs signaling and control functions for supporting access to network connection of the terminal, allocation of a network resource, tracking, paging, roaming, and handover. The MME controls control plane functions related to a subscriber and session management. The MME manages many eNodeBs and performs signaling for selection of a conventional gateway for handover of another 2G/3G network. Further, the MME performs a function of security procedures, terminal-to-network Session Handling, and idle terminal location management.

The SGSN handles entire packet data such as user mobility management and authentication of another 3GPP network (e.g., GPRS network).

The ePDG functions as a security node of an unreliable non-3GPP network (e.g., I-WLAN, WiFi hotspot).

Referring to FIG. 1, the UE having an IP capability may access to an IP service network (e.g., IMS) in which a provider (i.e., operator) provides via various elements within the EPC based on 3GPP access and non-3GPP access.

Further, FIG. 1 illustrates various reference points (e.g., S1-U, S1-MME). In the 3GPP system, a concept link that connects two functions existing at different functional entities of an E-UTRAN and an EPC is defined to a reference point. Table 1 represents a reference point of FIG. 1. In addition to an illustration of Table 1, various reference points may exist according to a network structure.

TABLE 1

| Reference | |
|---|---|
| point | Description |
| S1-MME | Reference point for the control plane protocol between |
| | E-UTRAN and MME |
| S1-U | Reference point between E-UTRAN and Serving GW |
| | for the per bearer user plane tunneling and inter eNodeB |
| | path switching during handover |
| S3 | It enables user and bearer information exchange for inter |
| | 3GPP access network mobility in idle and/or active state. |
| | This reference point can be used intra-PLMN or inter- |
| | PLMN (e.g. in the case of Inter-PLMN HO). |
| S4 | It provides related control and mobility support between |
| | GPRS Core and the 3GPP Anchor function of Serving GW. |
| | In addition, if Direct Tunnel is not established, it provides |
| | the user plane tunneling. |
| S5 | It provides user plane tunneling and tunnel management |
| | between Serving GW and PDN GW. It is used for Serving |
| | GW relocation due to the UE mobility and if the Serving |
| | GW needs to connect to a non-collocated PDN GW for the |
| | required PDN connectivity. |
| S11 | Reference point of the control plane protocol between |
| | MME and SGW |
| SGi | It is the reference point between the PDN GW and the |
| | packet data network. Packet data network may be an |
| | operator external public or private packet data network |
| | or an intra operator packet data network, e.g. for |
| | provision of IMS services. This reference point |
| | corresponds to Gi for 3GPP accesses. |

Among reference points of FIG. 1, S2a and S2b correspond to a non-3GPP interface. S2a is a reference point that provides related control and mobility resource between a reliable non-3GPP access and PDN GW to a user plane. S2b is a reference point that provides related control and mobility support between ePDG and PDN GW to a user plane.

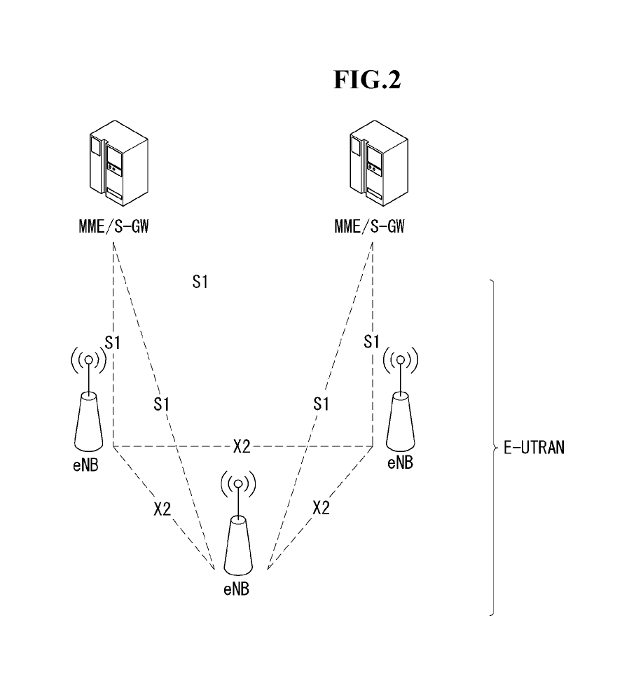

FIG. 2 illustrates an example of a network structure of an evolved universal terrestrial radio access network (E-UTRAN) to which the present invention can be applied.

The E-UTRAN system is an innovated system of an existing UTRAN system and may be, for example, a 3GPP LTE/LTE-A system. The communication network is widely disposed to provide various communication services such as a voice (e.g., Voice over Internet Protocol (VoIP)) through IMS and packet data.

Referring to FIG. 2, the E-UMTS network includes an E-UTRAN, an EPC, and at least one UE. The E-UTRAN is configured with eNBs that provide control plane and user plane protocols to the UE, and the eNBs are connected through an X2 interface.

An X2 user plane interface (X2-U) is defined between the eNBs. The X2-U interface provides non-guaranteed delivery of a user plane packet data unit (PDU). An X2 control plane interface (X2-CP) is defined between two neighboring eNBs. The X2-CP performs a function of context transfer between the eNBs, the control of a user plane tunnel between a source eNB and a target eNB, transfer of a handover related message, and uplink load management.

The eNB is connected to the UE through a wireless interface and is connected to an Evolved Packet Core (EPC) through an S1 interface.

An S1 user plane interface (S1-U) is defined between the eNB and a serving gateway (S-GW). An S1 control plane interface (S1-MME) is defined between the eNB and a mobility management entity (MME). The S1 interface performs an Evolved Packet System (EPS) bearer service management function, a non-access stratum (NAS) signaling transport function, network sharing, and a MME load balancing function. The S1 interface supports many-to-many-relation between the eNB and the MME/S-GW.

The MME may perform various functions of NAS signaling security, Access Stratum (AS) security control, Core Network (CN) Inter-CN signaling for supporting mobility between 3GPP access networks, IDLE mode UE reachability (including execution and control of paging retransmission), Tracking Area Identity (TAI) management (for idle and active mode terminal), PDN GW and SGW selection, MME selection for handover in which the MME is changed, SGSN selection for handover to a 2G or 3G 3GPP access network, roaming, authentication, a bearer management function including dedicated bearer establishment, and Public Warning System (PWS) (including an Earthquake and Tsunami Warning System (ETWS) and Commercial Mobile Alert System (CMAS)) message transmission support.

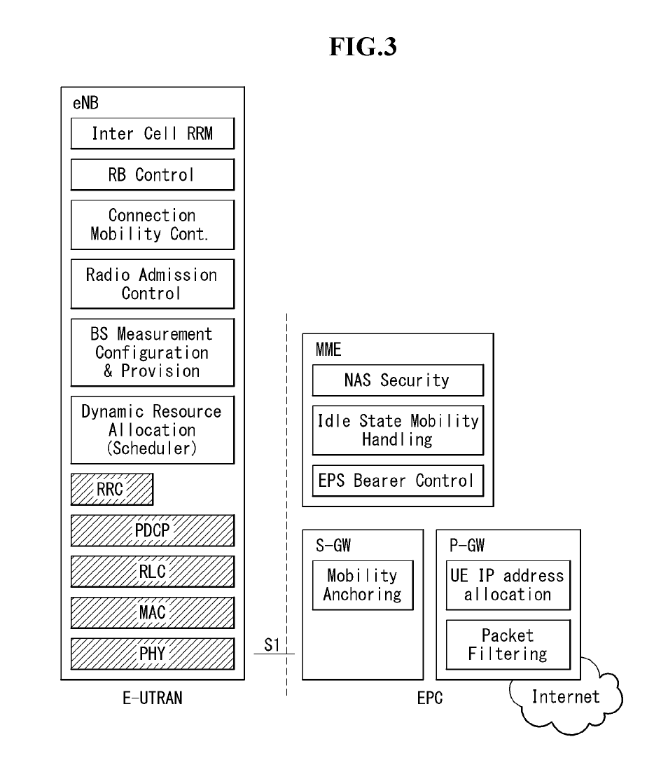

FIG. 3 illustrates a structure of an E-UTRAN and an EPC in a wireless communication system to which the present invention can be applied.

Referring to FIG. 3, the eNB may perform a function of selection of a gateway (e.g., MME), routing to a gateway for radio resource control (RRC) activation, scheduling and transmission of a broadcast channel (BCH), dynamic resource allocation to the UE in an uplink and a downlink, and mobility control connection in an LTE_ACTIVE state. As described above, a gateway within the EPC may perform a function of origination, LTE_IDLE state management, ciphering of a user plane, a System Architecture Evolution (SAE) bearer control, and ciphering and integrity protection of NAS signaling.

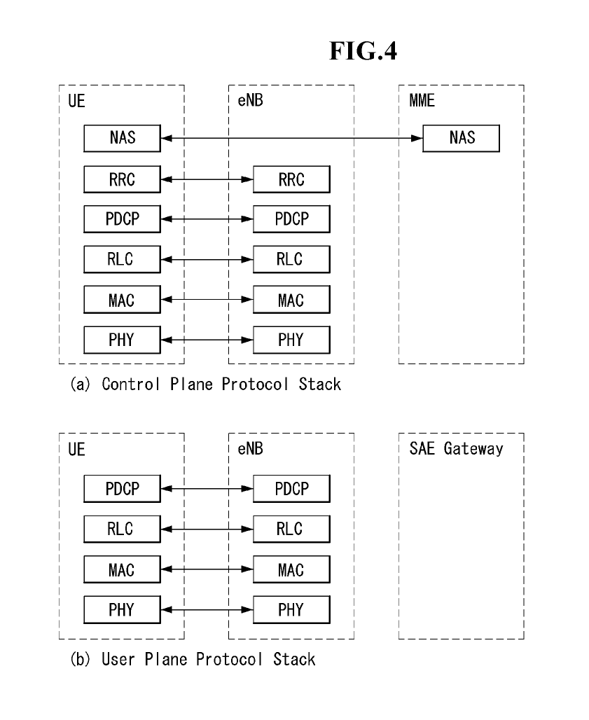

FIG. 4 illustrates a radio interface protocol structure between an UE and an E-UTRAN in a wireless communication system to which the present invention can be applied.

FIG. 4A illustrates a wireless protocol structure of a control plane, and FIG. 4B illustrates a wireless protocol structure of a user plane.

Referring to FIG. 4, layers of a wireless interface protocol between the UE and the E-UTRAN may be divided into a first layer L1, a second layer L2, and a third layer L3 based on subordinate 3 layers of an open system interconnection (OSI) standard model widely known in the art of a communication system. The wireless interface protocol between the UE and the E-UTRAN is horizontally formed with a physical layer, a data link layer, and a network layer and is vertically divided into a protocol stack user plane for transmitting data information and a control plane, which is a protocol stack for transferring signaling.

The control plane is a transmitting path of control messages in which the UE and the network use to manage a call. The user plane means a path that transmits data, for example, voice data or Internet packet data generated in an application layer. Hereinafter, each layer of a control plane and a user plane of a wireless protocol will be described.

By using a physical channel, a physical layer (PHY), which is a first layer L1 provides an information transfer service to a superordinate layer. The physical layer is connected to a medium access control (MAC) layer located at a superordinate level through a transport channel, and data are transmitted between the MAC layer and the physical layer through the transport channel. The transport channels are classified according to a method and feature in which data are transmitted through a wireless interface. Data are transmitted between different physical layers and between a physical layer of a transmitting terminal and a physical layer of a receiving terminal through the physical channel. The physical layer is modulated with an orthogonal frequency division multiplexing (OFDM) method and uses a time and a frequency as a radio resource.

There are several physical control channels used in a physical layer. The physical downlink control channel (PDCCH) notifies the UE of resource allocation of a paging channel (PCH) and a downlink shared channel (DL-SCH) and hybrid automatic repeat request (HARQ) information related to an uplink shared channel (UL-SCH). Further, the PDCCH may transmit UL grant that notifies resource allocation of uplink transmission to the UE. A physical control format indicator channel (PDFICH) notifies the UE of the number of OFDM symbols using for PDCCHs and is transmitted to every subframe. A physical HARQ indicator channel (PHICH) transmits a HARQ acknowledge (ACK)/non-acknowledge (NACK) signal in response to uplink transmission. A physical uplink control channel (PUCCH) transmits uplink control information such as HARQ ACK/NACK, a scheduling request, and a channel quality indicator (CQI) of downlink transmission. The physical uplink shared channel (PUSCH) transmits an UL-SCH.

A MAC layer of the second layer L2 provides a service to a radio link control (RLC) layer, which is a superordinate layer through a logical channel. Further, the MAC layer includes a mapping function between the logical channel and the transport channel and a multiplexing/demultiplexing function to a transport block provided to a physical channel on a transport channel of a MAC service data unit (SDU) that belongs to the logical channel.

An RLC layer of the second layer L2 supports reliable data transmission. A function of the RLC layer includes concatenation, segmentation, and reassembly of an RLC SDU. In order to guarantee various quality of services (QoS) in which a radio bearer (RB) requires, the RLC layer provides three operation modes of a transparent mode (TM), an unacknowledged mode (UM), and an acknowledge mode (AM). An AM RLC provides error correction through an automatic repeat request (ARQ). When the MAC layer performs an RLC function, the RLC layer may be included as a function block of an MAC layer.

A packet data convergence protocol (PDCP) layer of the second layer L2 performs a transfer function of user data in a user plane and a header compression and ciphering function. In order to efficiently transmit an Internet protocol (IP) packet such as Internet protocol version 4 (IPv4) or Internet protocol version 6 (IPv6) through a wireless interface having a small bandwidth, a header compression function means a function of reducing an IP packet header size having a relatively large size and that contains unnecessary control information. A function of a PDCP layer in the control plane includes transfer of control plane data and ciphering/integrity protection.

A radio resource control (RRC) layer located at a lowermost portion of a third layer L3 is defined to only a control plane. The RRC layer performs a function of controlling a radio resource between the UE and the network. For this reason, the UE and the network exchange an RRC message through the RRC layer. The RRC layer controls a logical channel, a transport channel, and a physical channel in relation to a configuration, a re-configuration, and release of radio bearers. For data transmission between the UE and the network, the radio bearer means a logical path provided by the second layer L2. A configuration of a radio bearer means prescription of a feature of a wireless protocol layer and a channel in order to provide a specific service and a configuration of each detailed parameter and operation method. The radio bearer may be again divided into two of signaling RB (SRB) and data RB (DRB). The SRB is used as a path that transmits an RRC message at the control plane, and the DRB is used as a path that transmits user data at the user plane.

A non-access stratum (NAS) layer located as a superordinate layer of the RRC layer performs a function of session management and mobility management.

One cell constituting a base station is set to one of bandwidths such as 1.25, 2.5, 5, 10, and 20 Mhz to provide a downlink or uplink transmission service to several UEs. Different cells may be set to provide different bandwidths.

A downlink transport channel that transmits data from the network to the UE includes a broadcast channel (BCH) that transmits system information, a PCH that transmits a paging message, and a DL-SCH that transmits user traffic or a control message. Traffic or a control message of downlink multicast or a broadcasting service may be transmitted through the DL-SCH or through a separate downlink multicast channel (MCH). An uplink transport channel that transmits data from the UE to the network includes a random access channel (RACH) that transmits an initial control message and an uplink shared channel (UL-SCH) that transmits user traffic or a control message.

The logical channel is a superordinate channel of the transport channel and is mapped to the transport channel. The logical channel may be divided into a control channel for transfer of control area information and a traffic channel for transfer of user area information. The control channel includes a broadcast control channel (BCCH), a paging control channel (PCCH), a common control channel (CCCH), a dedicated control channel (DCCH), and a multicast control channel (MCCH). The traffic channel includes a dedicated traffic channel (DTCH) and a multicast traffic channel (MTCH). The PCCH is a downlink channel that transfers paging information and is used when a network does not know a cell to which the UE belongs. The CCCH is used by the UE that does not have RRC connection to the network. The MCCH is a point-to-multipoint downlink channel used for transferring Multimedia Broadcast and Multicast Service (MBMS) control information from the network to the UE. The DCCH is a point-to-point bi-directional channel used by the UE having RRC connection that transfers dedicated control information between the UE and the network. The DTCH is a point-to-point channel used for only one UE in order to transfer user information that can exist at an uplink and a downlink. The MTCH is a point-to-multipoint downlink channel in order to transfer traffic data from the network to the UE.

In uplink connection between the logical channel and the transport channel, the DCCH may be mapped to the UL-SCH, the DTCH may be mapped to the UL-SCH, and the CCCH may be mapped to the UL-SCH. In downlink connection between the logical channel and the transport channel, the BCCH may be mapped to the BCH or the DL-SCH, the PCCH may be mapped to the PCH, the DCCH may be mapped to the DL-SCH, the DTCH may be mapped to the DL-SCH, the MCCH may be mapped to the MCH, and the MTCH may be mapped to the MCH.

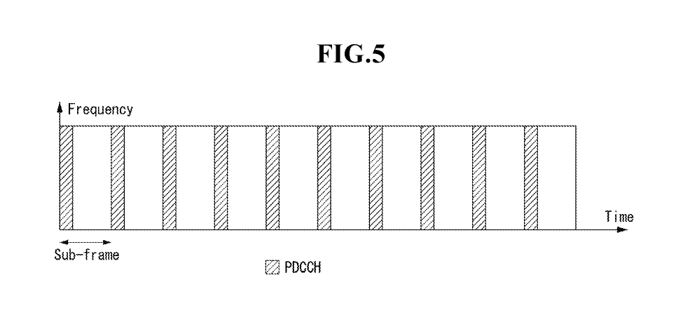

FIG. 5 illustrates a structure of a physical channel in a wireless communication system to which the present invention can be applied.

Referring to FIG. 5, the physical channel transfers signaling and data through a radio resource configured with at least one subcarrier in a frequency domain and at least one symbol in a time domain.

One subframe having a length 1.0 ms is configured with a plurality of symbols. Specific symbol(s) (e.g., a first symbol of the subframe) of the subframe may be used for a PDCCH. The PDCCH transmits information (e.g., resource block) about a dynamically allocated resource and a Modulation and Coding Scheme (MCS).

Random Access Procedure

Hereinafter, a random access procedure providing in an LTE/LTE-A system will be described.

Because the UE does not have RRC Connection to the base station, when the UE performs initial access in an RRC idle state, the random access procedure is performed when performing an RRC connection re-establishment procedure.

In the LTE/LTE-A system, in a process of selecting a random access preamble (RACH preamble), the UE provides both a contention based random access procedure that randomly selects and uses one preamble and a non-contention based random access procedure in which a base station allocates to only a specific UE within a specific set.

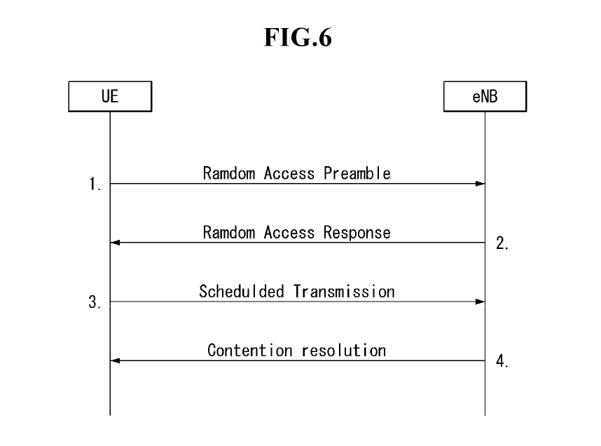

FIG. 6 illustrates a contention based random access procedure in a wireless communication system to which the present invention can be applied.

(1) Msg 1 (Message 1)

First, the UE randomly selects one random access preamble (RACH preamble) at a set of random access preambles instructed through system information or a handover command and selects and transmits a physical RACH (PRACH) resource that can transmit the random access preamble.

The base station, having received a random access preamble from the UE decodes the preamble and acquires an RA-RNTI. The RA-RNTI related to the PRACH in which the random access preamble is transmitted is determined according to a time-frequency resource of a random access preamble in which a corresponding UE transmits.

(2) Msg 2 (Message 2)

The base station transmits a random access response addressed with the RA-RNTI acquired through a preamble on a message 1 to the UE. The random access response may include an RA preamble index/identifier, UL grant that notifies an uplink wireless resource, a Temporary Cell RNTI (TC-RNTI), and a time alignment command (TAC). The TAC is information that addresses a time synchronization value in which the base station sends to maintain uplink time alignment to the UE. The UE updates uplink transmission timing using the time synchronization value. When the UE updates time synchronization, the UE starts or restarts a time alignment timer. UL grant includes uplink resource allocation and transmit power command (TPC) used for transmission of a scheduling message (a message 3) to be described later. The TPC is used in determination of transmission power for a scheduled PUSCH.

After the UE transmits a random access preamble, the base station attempts reception of a random access response thereof within a random access response window addressed through system information or handover command, detects a masked PDCCH with the RA-RNTI corresponding to the PRACH, and receives a PDSCH addressed by the detected PDCCH. Random access response information may be transmitted in a form of a MAC packet data unit (MAC PDU), and the MAC PDU may be transferred through the PDSCH.

When the UE successfully receives a random access response having the same random access preamble index/identifier as that of a random access preamble transmitted to the base station, the UE stops monitoring of a random access response. However, until a random access response window is terminated, when the UE does not receive a random access response message or when the UE does not receive an effective random access response having the same random access preamble index as that of a random access preamble transmitted to the base station, it is regarded that reception of the random access response is failed and then the UE may retransmit the preamble.

(3) Msg 3 (Message 3)

When the UE receives an effective random access response, the UE processes each information included in the random access response. That is, the UE applies TAC and stores a TC-RNTI. Further, the UE transmits data stored at a buffer of the UE or newly generated data to the base station using UL grant.

In initial access of the UE, an RRC Connection Request generated in the RRC layer and transferred through the CCCH may be included and transmitted in the message 3, and in an RRC connection re-establishment procedure, an RRC Connection Re-establishment Request generated at the RRC layer and transferred through the CCCH may be included and transmitted in the message 3. Further, the message 3 may include a NAS access request message.

The message 3 should include an identifier of the UE. There are two methods of including an identifier of the UE. In a first method, when the UE already has an effective cell identifier (C-RNTI) allocated from a corresponding cell before the random access procedure, the UE transmits a cell identifier thereof through an uplink transmitting signal corresponding to the UL grant. However, when the UE does not have an effective cell identifier (C-RNTI) allocated from a corresponding cell before the random access procedure, the UE transmits a message 3 including a unique identifier (e.g., S-TMSI or random number) thereof. The unique identifier is generally longer than the C-RNTI.

When the UE transmits data corresponding to the UL grant, the UE starts a contention resolution timer.

(4) Msg 4 (Message 4)

When the base station receives the C-RNTI of a corresponding UE through the message 3 from the UE, the base station transmits a message 4 to the UE using the received C-RNTI. However, when the base station receives the unique identifier (i.e., S-TMSI or random number) from the UE through the message 3, the base station transmits the message 4 to the UE using a TC-RNTI allocated to the corresponding UE in a random access response. For example, the message 4 may include RRC Connection Setup.

The UE transmits data including an identifier thereof through UL grant included in the random access response and awaits an instruction of the base station in order to resolute contention. That is, in order to receive a specific message, the UE attempts reception of a PDCCH. There are two methods of receiving the PDCCH. As described above, in the message 3 transmitted to correspond to the UL grant, when an identifier thereof is a C-RNTI, the UE attempts reception of the PDCCH using the C-RNTI, and when the identifier is an unique identifier (i.e., S-TMSI or random number), the UE attempts reception of the PDCCH using a TC-RNTI included in the random access response. Thereafter, in the former case, before the contention resolution timer is terminated, when the UE receives the PDCCH through the C-RNTI thereof, the UE determines that a random access procedure has been normally performed and terminates the random access procedure. In the latter case, before the contention resolution timer is terminated, when the UE receives the PDCCH through the TC-RNTI, the UE determines data in which a PDSCH addressed by the PDCCH transfers. When a unique identifier thereof is included in the data, the UE determines that a random access procedure has been normally performed and terminates the random access procedure. The UE acquires a C-RNTI through the message 4 and the UE and the network transmit and receive a dedicated message using the C-RNTI.

In an operation in a non-contention based random access process, a random access procedure is terminated with only first message transmission and second message transmission unlike a contention-based random access process of FIG. 6. However, before the UE transmits a random access preamble to the base station with the message 1, the UE receives allocation of the random access preamble from the base station, transmits the allocated random access preamble to the base station with the message 1, and receives a random access response from the base station and thus the random access procedure is terminated.

The terms used in the present description are defined as follows:
Access Security Management Entity (ASME): an entity that receives the top-level key(s) within the access network from the HSS. In the case of an E-UTRAN access network, the role of the ASME is performed by the MME.
Authentication data: data which is a part of security context or authentication vectors
Authentication vectors: Access Security Management Entity key (K_ASME), RANDom number (RAND), authentication token (AUTN), and Expected Response (XRES)
EPS security context: A state established locally in the UE and the serving network domain. “EPS security context data” is stored in the UE and the serving network domain, which includes an EPS NAS (Non-Access Stratum) security context and an EPS AS (Access Stratum) security context.
UE security capabilities: A set of identifiers corresponding to the ciphering and integrity algorithms implemented in the UE. This may include capabilities for EPS AS and NAS, and may include capabilities for UTRAN and GERAN (if such access type is supported by the UE). The UE security capability information element is used by the network to indicate which security algorithms are supported by the UE in S1 mode. Security algorithms supported in S1 mode are supported both for NAS and for AS security.

Algorithm Negotiation

Hereinafter, requirements for algorithm selection will be described.

a) An active UE and a serving network shall agree upon algorithms for
RRC ciphering and RRC integrity protection (to be used between UE and eNB)
user plane (UP) ciphering (to be used between UE and eNB)
NAS ciphering and NAS integrity protection (to be used between UE and MME)

An active relay node (RN) and a network serving the RN shall additionally agree upon algorithms for UP integrity.

b) The serving network shall select the algorithms to use dependent on
the UE security capabilities of the UE,
the configured allowed list of security capabilities of the currently serving network entity

c) The same set of ciphering and integrity algorithms shall be supported by the UE both for AS and NAS level.

d) Each selected algorithm shall be acknowledged to the UE in an integrity protected way such that the UE is ensured that the algorithm selection was not manipulated, i.e. that the UE security capabilities were not bidden down.

e) The UE security capabilities the mobile equipment (ME) sent to the network shall be repeated in an integrity protected NAS level message to the ME such that “bidding down attacks” against the UE's security capabilities can be detected by the ME. The UE security capabilities apply to both AS and NAS level security.

f) Separate AS and NAS level security mode command procedures are required. AS level security mode command procedure shall configure AS security (RRC and UP) and NAS level security mode command procedure shall configure NAS security.
Both integrity protection and ciphering for RRC shall be activated within the same AS Security Mode Command (SMC) procedure, but not necessarily within the same message.
User plane ciphering shall be activated at the same time as RRC ciphering.
User plane integrity shall be activated at the same time as RRC ciphering. User plane integrity shall be applied to a data radio bearer if integrity protection is configured for that data radio bearer at the time of data radio bearer set-up.

g) It shall be possible that the selected AS and NAS algorithms are different at a given point of time.

Hereinafter, procedures for AS algorithm selection will be described.

1) Initial AS Security Context Establishment

Each eNB shall be configured via network management with lists of algorithms which are allowed for usage. There shall be one list for integrity algorithms, and one for ciphering algorithms. These lists shall be ordered according to a priority decided by the operator. When AS security context is established in the eNB, the MME shall send the UE EPS security capabilities to the eNB. The eNB shall choose the ciphering algorithm which has the highest priority from its configured list and is also present in the UE EPS security capabilities. The eNB shall choose the integrity algorithm which has the highest priority from its configured list and is also present in the UE EPS security capabilities. The chosen algorithms shall be indicated to the UE in the AS SMC. The ciphering algorithm is used for ciphering of the user plane and RRC traffic. The integrity algorithm is used for integrity protection of the RRC traffic, and, if applicable, for the integrity protection of user plane traffic between RN and Donor eNB (DeNB).

2) X2-Handover

At handover from a source eNB over X2 to a target eNB, the source eNB shall include the UE EPS security capabilities and ciphering and integrity algorithms used in the source cell in the handover request message. The target eNB shall select the algorithm with highest priority from the UE EPS security capabilities according to the prioritized locally configured list of algorithms (this applies for both integrity and ciphering algorithms). The chosen algorithms shall be indicated to the UE in the handover command if the target eNB selects different algorithms compared to the source eNB. If the UE does not receive any selection of integrity and ciphering algorithms it continues to use the same algorithms as before the handover. In the path-switch message, the target eNB shall send the UE EPS security capabilities received from the source eNB to the MME. The MME shall verify that the UE EPS security capabilities received from the eNB are the same as the UE EPS security capabilities that the MME has stored. If there is a mismatch, the MME may log the event and may take additional measures, such as raising an alarm.

3) S1-Handover

At handover from a source eNB to a target eNB over S1 (possibly including an MME change and hence a transfer of the UE security capabilities from source MME to target MME), the target MME shall send the UE EPS security capabilities to the target eNB in the S1 AP HANDOVER REQUEST message. The target eNB shall select the algorithm with highest priority from the UE EPS security capabilities according to the prioritized locally configured list of algorithms (this applies for both integrity and ciphering algorithms). The chosen algorithms shall be indicated to the UE in the handover command if the target eNB selects different algorithms compared to the source eNB. If the UE does not receive any selection of integrity and ciphering algorithms it continues to use the same algorithms as before the handover.

4) Intra-eNB Handover

It is not required to change the AS security algorithm during intra-eNB handover. If the UE does not receive any selection of new AS security algorithms during an intra-eNB handover, the UE continues to use the same algorithms as before the handover.

Hereinafter, procedures for NAS algorithm selection will be described.

1) Initial NAS Security Context Establishment

Each MME shall be configured via network management with lists of algorithms which are allowed for usage. There shall be one list for NAS integrity algorithms, and one for NAS ciphering algorithms. These lists shall be ordered according to a priority decided by the operator.

To establish the NAS security context, the MME shall choose one NAS ciphering algorithm and one NAS integrity protection algorithm. The MME shall then initiate a NAS security mode command procedure, and include the chosen algorithms and UE security capabilities (to detect modification of the UE security capabilities by an attacker) in the message to the UE. The MME shall select the NAS algorithms which have the highest priority according to the ordered lists.

2) MME Change

In case there is change of MMEs and algorithms to be used for NAS, the target MME shall initiate a NAS security mode command procedure and include the chosen algorithms and the UE security capabilities (to detect modification of the UE security capabilities by an attacker) in the message to the UE. The MME shall select the NAS algorithms which have the highest priority according to the ordered lists.

Security Mode Command Procedure

Hereinafter, NAS security mode command (SMC) procedure will be described.

The MME uses the SMC procedure to establish a NAS security association between the UE and MME, in order to protect the further NAS signaling messages. This procedure is also used to make changes in the security association, e.g. to change the security algorithm.

The NAS Security Mode Command procedure may be executed as part of the Attach procedure in advance of, or in combination with, executing the ME Identity Check procedure and in the Tracking Area Update (TAU) procedure.

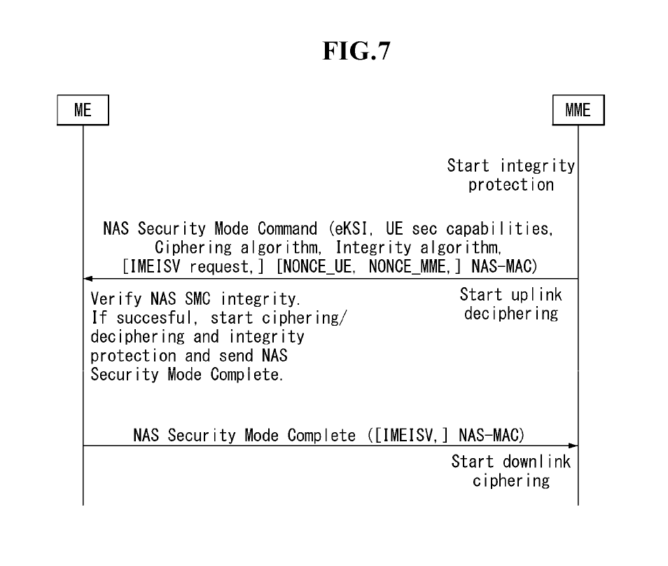

FIG. 7 illustrates a NAS security mode command procedure in a wireless communication system to which the present invention can be applied.

The NAS SMC procedure consists of a roundtrip of messages between MME and UE. The MME sends the NAS security mode command message to the UE and the UE replies with the NAS security mode complete message.

The MME initiates the NAS security mode control procedure by sending a SECURITY MODE COMMAND message to the UE.

The MME shall send the SECURITY MODE COMMAND message unciphered, but shall integrity protect the message with the NAS integrity key based on K_ASME or mapped K′_ASME indicated by the eKSI included in the message. The MME shall set the security header type of the message to “integrity protected with new EPS security context”.

The MME shall include the replayed security capabilities of the UE (including the security capabilities with regard to NAS, RRC and UP (user plane) ciphering as well as NAS and RRC integrity, and other possible target network security capabilities, i.e. UTRAN/GERAN if the UE included them in the message to network), the replayed nonceUE when creating a mapped EPS security context and if the UE included it in the message to the network, the selected NAS ciphering and integrity algorithms and the Key Set Identifier (eKSI).

Upon receipt of the SECURITY MODE COMMAND message, the UE shall check whether the security mode command can be accepted or not. This is done by performing the integrity check of the message and by checking that the received replayed UE security capabilities and the received nonce_UE have not been altered compared to the latest values that the UE sent to the network.

If the SECURITY MODE COMMAND message can be accepted, the UE shall send a SECURITY MODE COMPLETE message integrity protected with the selected NAS integrity algorithm and the EPS NAS integrity key based on the K_ASME or mapped K′_ASME if the type of security context flag is set to “mapped security context” indicated by the eKSI. When the SECURITY MODE COMMAND message includes the type of security context flag set to “mapped security context” in the NAS key set identifier IE, the nonceMME and the nonceUE, then the UE shall either:
generate K′_ASME from both the nonce_MME and the nonce_UE; or
check whether the SECURITY MODE COMMAND message indicates the eKSI of the current EPS security context, if it is a mapped EPS security context, in order not to re-generate the K′_ASME.

Furthermore, if the SECURITY MODE COMMAND message can be accepted, the UE shall cipher the SECURITY MODE COMPLETE message with the selected NAS ciphering algorithm and the EPS NAS ciphering key based on the K_ASME or mapped K′_ASME indicated by the eKSI. The UE shall set the security header type of the message to “integrity protected and ciphered with new EPS security context”.

More details of the procedure will be described.

The NAS security mode command message from MME to UE shall contain the replayed UE security capabilities, the selected NAS algorithms, the eKSI for identifying K_ASME, and both NONCE_UE and NONCE_MME in the case of creating a mapped context in idle mobility. This message shall be integrity protected (but not ciphered) with NAS integrity key based on K_ASME indicated by the eKSI in the message.

The UE shall verify the integrity of the NAS security mode command message. This includes ensuring that the UE security capabilities sent by the MME match the ones stored in the UE to ensure that these were not modified by an attacker and checking the integrity protection using the indicated NAS integrity algorithm and the NAS integrity key based on K_ASME indicated by the eKSI. In addition, when creating a mapped context, the UE shall ensure the received NONCE_UE is the same as the NONCE_UE sent in the Tracking Area Update (TAU) Request and also calculate K′_ASME from CK, IK and the two nonces.

If the MME receives no response to a NAS Security Mode Command that included nonces to create a mapped context and it wishes to try again to create the mapped context, the MME shall use the same values of NONCE_UE and NONCE_MME.

If the UE receives a re-transmitted NAS Security Mode Command, i.e one containing the nonces, after it has successfully received a previous one (and hence created a mapped EPS NAS security context), the UE shall process the message as above, except that it is not required to re-generate the K′_ASME or check the NONCE_UE if it does not re-generate the K′_ASME.

If the checks of the NAS Security Mode Command pass the UE shall respond with a NAS Security Mode Complete.

The UE shall delete NONCE_UE once the TAU procedure is complete.

If successfully verified, the UE shall start NAS integrity protection and ciphering/deciphering with this security context and sends the NAS security mode complete message to MME ciphered and integrity protected The NAS security mode complete message shall include International Mobile Station Equipment Identity and Software Version number (IMEISV) in case MME requested it in the NAS SMC Command message.

The MME shall de-cipher and check the integrity protection on the NAS Security Mode Complete using the keys and algorithms indicated in the NAS Security Mode Command. NAS downlink ciphering at the MME with this security context shall start after receiving the NAS security mode complete message. NAS uplink deciphering at the MME with this context starts after sending the NAS security mode command message.

If any verification of the NAS security mode command is not successful in the ME, the ME shall reply with a NAS security mode reject message. The NAS security mode reject message and all following NAS messages shall be protected with the EPS NAS security context, i.e., the EPS NAS security context used prior to the NAS security mode command that failed (until a new EPS NAS security context is established, e.g., via a new NAS security mode command procedure). If no EPS NAS security context existed prior to the NAS security mode command, the NAS security mode reject message cannot be protected.

Hereinafter, AS security mode command (SMC) procedure will be described.

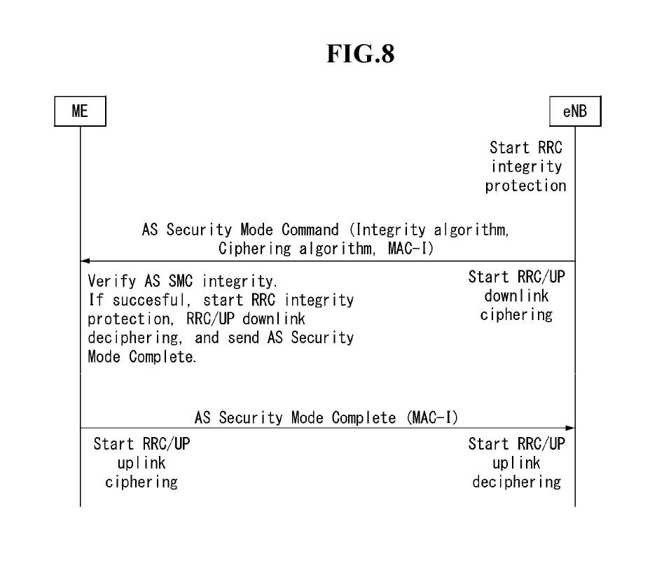

FIG. 8 illustrates a AS security mode command procedure in a wireless communication system to which the present invention can be applied.

The AS SMC procedure consists of a roundtrip of messages between eNB and UE. The eNB sends the AS security mode command to the UE and the UE replies with the AS security mode complete message.

The AS security mode command message from eNB to UE shall contain the selected AS algorithms. This message shall be integrity protected with RRC integrity key based on the current K_ASME.

The AS security mode complete message from UE to eNB shall be integrity protected with the selected RRC algorithm indicated in the AS security mode command message and RRC integrity key based on the current K_ASME.

RRC and UP downlink ciphering (encryption) at the eNB shall start after sending the AS security mode command message. RRC and UP uplink deciphering (decryption) at the eNB shall start after receiving and successful verification of the AS security mode complete message.

RRC and UP uplink ciphering (encryption) at the UE shall start after sending the AS security mode complete message. RRC and UP downlink deciphering (decryption) at the UE shall start after receiving and successful verification of the AS security mode command message

If any control of the AS security mode command is not successful in the ME, the ME shall reply with an unprotected security mode failure message.

AS security mode command always changes the AS keys.

Hereinafter, algorithm negotiation for unauthenticated UEs in limited service mode (LSM) will be described.

In general, a UE may be referred to as a LSM state because it is a USIM that is not known to the network or that is not capable of authenticating to the network because the USIM does not exist.

UEs that are in limited service mode (LSM) and that cannot be authenticated by the MME (for whatever reason) may still be allowed to establish emergency calls by sending the emergency attach request message. It shall be possible to configure whether the MME allows unauthenticated UEs in LSM to establish bearers for emergency calls or not. If an MME allows unauthenticated UEs in LSM to establish bearers for an emergency call, the MME shall for the NAS protocol use EPS Integrity Algorithm 0 (EIA0) and EPS Encryption Algorithm (EEA0) as the integrity and ciphering algorithm respectively.

EIA0 indicates a null integrity protection algorithm, and EEA0 indicates a null ciphering algorithm.

If the MME allows an unauthenticated UE in LSM to establish bearers for emergency calls after it has received the emergency attach request message from the UE, the MME shall:
Select EIA0 and EEA0, regardless of the supported algorithms announced previously by the UE as the NAS algorithms and signal this to the UE via the NAS security mode command procedure when activating the EPS NAS security context.
Set the UE EPS security capabilities to only contain EIA0 and EEA0 when sending these to the eNB in the following messages: S1 UE INITIAL CONTEXT SETUP, S1 UE CONTEXT MODIFICATION REQUEST, S1 HANDOVER REQUEST

The rules for when the MME shall select EIA0 for NAS integrity protection, and when the UE shall accept a NAS security mode command selecting EIA0 for NAS integrity protection depends on whether the UE and MME can be certain that no EPS NAS security context can be established. The rules for determining this is defined in clause 15 of this specification. If the MME has selected EIA0 as the NAS integrity protection algorithm, the UE shall accept selection of EIA0 as the AS integrity protection algorithm. Selection of AS integrity protection algorithm happens via the AS security mode command procedure or via a handover command. The UE shall under no other circumstances accept selection of EIA0 as the AS integrity protection algorithm.

Security Visibility and Configurability

Although in general the security features should be transparent to the user, for certain events and according to the user's concern, greater user visibility of the operation of following security feature shall be provided:
indication of access network encryption: the property that the user is informed whether the confidentiality of user data is protected on the radio access link, in particular when non-ciphered calls are set-up;

Configurability is the property that the user can configure whether the use or the provision of a service should depend on whether a security feature is in operation. A service can only be used if all security features, which are relevant to that service and which are required by the configurations of the user, are in operation. The following configurability features are suggested:
enabling/disabling user-USIM authentication: the user should be able to control the operation of user-USIM authentication, e.g., for some events, services or use.

Security Indication and Controlling Method

As explained above, in the conventional case, when the user connects to the 3GPP system or starts the service after the connection (e.g., user plane data transmission), It is not available or difficult to know a security provided by the system or the service (e.g., an authentication method, an encryption (or ciphering) algorithm (including the key length), an integrity algorithm, etc.). Similarly, it is not available to select the desired security or forward it to the system.

In this case, regardless of the level of security actually applied, the user may send and receive sensitive data, by recognizing that the desired level of security has been selected, or that the existing selection is still maintained.

However, it is highly probable to be attacked, depending on the security currently provided. For example, an attacker may be able to acquire sensitive data or user information, by inducing a user terminal to connect to a fake base station using a weak algorithm, and may be able to attack by providing falsified data or malicious code to the user. As another example, it might be the subject to the bidding down attack.

In order to solve this problem, 3GPP is currently discussing the following issues and requirements for the Next Generation System, but no solution on the issues has been proposed yet.

1) Key Issue #1: User Awareness of Security
Key issue details: Next generation system is expected to diverse access networks, services, and UE types. Different networks or services may have different security capabilities, but the implication of it may hardly be understood by users. Since this could mislead users to mistakenly trust or doubt the current service or access networks, and make harmful decision, there should be some way to let users be aware of major security implications (e.g. fallback to weak security).
Security threats: Attackers could specifically target UEs in access networks or services with weak security, while users do not fully understand the situation, so for users to do sensitive transactions over the less secure environment. In general, this will make UEs more vulnerable.

Active attackers could make a UE move to less secure service or access network (e.g. by jamming the current serving eNB or network). Downgrade of security will make UEs and users more vulnerable.

Active attackers might let user to believe it is attached to a secure service or access network, while it is not the case in reality.

Potential Security Requirements:

UEs shall be able to present users of security indication of current services or access networks. In addition, detail information including security capability or parameters may be presented for the advanced users' reference.

Access networks and services should be able to provide information to UEs, which is necessary to derive security indication for users.

UEs should be able to collect security capabilities of access networks and services, and derive security indication for users from those parameters.

UEs should be able to validate security indication related information from network.

2) Key Issue: User Control of Security
Key issue details: Assuming that a user (and a UE) comes to aware of some of security capability of access networks or services, whether such information is provided by networks or services, or the UE derives it from other procedures, the user (or the UE) may need to control the security to its preference.
Security threats: Although a user is aware of security level, if the access network or service selection is based on the other factors than security, the user (and a UE) might have no choice but to use less secure ones. Attackers could make use of this, and lead users (and UEs) to less secure situations. This will make more secure services or access networks unavailable to UEs.

Attackers could try bid-down attack in the middle of network and a UE, to lead to use least secure parameters.

Potential Security Requirements:

UEs shall provide users with means to select from available access networks or services, based on security capabilities (or security levels) of access networks or services.

UEs shall provide users with means to configure minimum (or preferred) security capabilities (e.g. levels or parameters) which UEs shall try to satisfy when UEs choose or negotiate with access networks or services. There might be pre-defined default configuration of minimum (or preferred) security capabilities.

UEs shall be able to send the preferred security capability (or parameters, possible security levels, if agreed) to access networks or services. Access networks or services should try to meet the request from UE and provide acknowledgement whether the requested security is achieved or not.

The present invention proposes the following methods and procedures as a method for solving security vulnerabilities arising from the problems of the above-described prior arts.

First, the policy format may be determined as follows to notify (indicate) a user of security.

Hereinafter, in the description of the present invention, a policy for notifying security to a user may be referred to as a ‘configuration of a security indication’.

In addition, the determined policy format may be applied to a security set-up procedure etc. of the UE and the system (or Network), (e.g., a security mode command procedure).

The indication of security capabilities is useful in that it provides opportunities for a user can aware unusual situation or gap between expected security and provided security.

Downgrade of security between handover/roaming could be an example of the latter (i.e. the user expected the same security during the service). Weak (or weakest) security algorithm/method (but legitimate in the spec, whether it is backward compatibility or not) could be a case for the former. However, this weaker security than conventional cases is hard to define as a fixed value (attacks could evolve and vulnerabilities might be discovered later in time). Therefore it is only reasonable to be capable of update the indication policy by operators (possibly guided by standardization organization such as 3GPP or operator partnerships such as GSMA, for example).

User indication policy (file) of security (i.e., configuration of security indication) is downloaded to Universal Integrated Circuit Card (UICC) or protected storage of equipment, through existing over the air (OTA) mechanism (with protection during OTA).

User indication policy of security (i.e., configuration of security indication) is specified as following:

Security Capability Item, Condition

That is, the configuration of security indication may include one or more security capability items and an indication condition of each security capability item.

For example, an indication condition of a security capability item may include a list of one or more noticeable values of a security capability item.

That is, the indication condition may indicate one or more values of the security capability item. In this case, if the security information determined by the network and delivered to the UE indicates same value as one or more values of the security capability item indicated by the indication condition, the UE may perform notification on the corresponding security capability item. For example, if the configuration of security indication is set to (AS encryption algorithm, (none, UMTS)), the UE may perform notification to the user when there is no AS encryption algorithm indicated by the security information or when the AS encryption algorithm of the UMTS level is indicated by the security information.

Further, the indication condition of the security capability item may include a change of value of the corresponding security capability item actually applied to the communication between the UE and the network (i.e., changes of item value applied to the connection). That is, it means the case that the security information indicates a value different from a value applied to communication between the UE and the network for the security capability item, and thereby the value applied to the communication between the UE and the network is changed. In this case, if a security algorithm that is different from the security algorithm applied to the communication between the UE and the network for the security capability item set by the configuration of the security indication is indicated by security information (that is, If the value applied to the communication between the networks is changed), the UE may perform notifications for the corresponding security capability item. For example, if the configuration of security indication is set to (AS encryption algorithm, (downgrade)), when the value changes to a lower value than the AS encryption algorithm currently applied communication between the UE and the network (for example, when the AS encryption algorithm is changed from LTE to UMTS or GSM/GPRS, or when the AS encryption algorithm is changed from AES256 to AES128), the UE may perform the notification to the user.

Herein, the security capability item may include a security feature, capability, method, etc., such as an authentication method, a (user data) encryption (or ciphering) algorithm, and/or (user data) integrity protection algorithm, subscriber identity privacy or the like.

For example, the Null Confidentiality, Null Integrity Protection algorithm (i.e., EEA0 and EIA0) (for the case that a confidentiality, an integrity protection is not applied), SNOW 3G based algorithm (i.e., 128-EEA1 and 128-EIA1) (one of the a confidentiality, an integrity algorithm used in 3GPP), Advanced Encryption Standard (AES) based algorithm (i.e., 128-EEA2 and 128-EIA2), ZUC based algorithm (i.e., 128-EEA3 and 128-EIA3) or the like, as an Confidentiality, Integrity algorithm presented in 3GPP TS 33.401, may be used as a security capability item.

Further, new security algorithms may be added (for integrity, encryption, authentication, etc.) and may be used as a security capability item in the 3GPP 5G or the NextGen system (i.e., the next generation cellular mobile communication standard standardized later from Rel-14 beyond the 4G in 3GPP) It can be used as an item.

Hereinafter, the value of the security capability item will be described

For example, in the case of the encryption (ciphering) algorithm, each encryption (ciphering) algorithm may be specified with a 4-bit identifier. As an example, the following values may be defined.
“0000” (Binary number): EEA0, i.e., Null ciphering algorithm
“0001” (Binary number): 128-EEA1, i.e., SNOW 3G based algorithm
“0010” (Binary number): 128-EEA2, i.e., AES based algorithm
“0011” (Binary number): 128-EEA3, i.e., ZUC based algorithm

As another example, in the case of the integrity protection algorithm, each integrity protection algorithm may be specified with a 4-bit identifier. As an example, the following values may be defined.
“0000” (Binary number): EIA0, i.e., Null Integrity Protection algorithm
“0001” (Binary number): 128-EIA1, i.e., SNOW 3G based algorithm
“0010” (Binary number): 128-EIA2, i.e., AES (Advanced Encryption Standard) based algorithm
“0011” (Binary number): 128-EIA3, i.e., ZUC based algorithm

An example of a configuration of security indication configured based on the above description is as follows.

i) Example 1: integrity protection algorithm, (Null Integrity Protection algorithm, SNOW 3G based algorithm)

If the integrity algorithm is null or snow 3G based one, a user will be notified by a UE.

ii) Example 2: encryption algorithm, (downgrade)

When the encryption algorithm is downgraded, a user will be notified by a UE.

iii) Example 3: authentication method, (other than new NG authentication)

When the authentication method is other than newly specified ones in next generation (NG), a user will be notified by a UE.

The security capability item and values exemplified above are only one example for convenience of explanation and may be further categorized or added.

Further, while the present invention is in use, the security capability item and values may be added to a vulnerability to be found later or an algorithm/capability to be additionally introduced.

The way how to present these security indication to users is an implementation issue (e.g. pop-up, status bar, icon, sound, or (LED: light emitting diode) indicator light), but the requirement will be mandated for assurance:
Security indication/notification should be relatively stay. (i.e. if it is pop-up, that should stay on top of the screen of UE, until the user explicitly confirm, not closing after specified period of time.)
Security indication/notification feature could be turned off by explicit choice of user in the configuration (i.e. setting menu). The default setting is “on”.
Users can configure the security indication/notification policy (i.e., configuration of security indication) through configuration/setting menu of UE, which may override the operator policy.
The more detail security capabilities are found in the configuration/setting menu of UE, for advanced users or other purposes.

Next, the policy format for control security may be determined as follows.

Hereinafter, in the description of the present invention, a policy for controlling security may be referred to as a ‘configuration of security control’.

Default or standard user control policy (file) of security (i.e., configuration of security control) is downloaded to UICC or protected storage of equipment, through existing OTA mechanism (with protection during OTA).

Users may modify this in the configuration/setting menu of UE anytime, and user configuration may override the default/standard configuration. User control policy of security (i.e., configuration of security control) is specified as following:
Security capability item, condition list (value list of items, or changes of item value), action(s)

That is, the configuration of security control may include one or more security capability items, a control condition of each security capability item, and an action of the UE according to a control condition.

For example, the control condition of the security capability item may include a list of one or more values of the security capability item (value list of items).

That is, the control condition may indicate one or more values of the security capability item. In this case, if the security information determined by the network and delivered to the UE indicates same value as one or more values of the security capability item indicated by the control condition, the UE may perform an action on the corresponding security capability item.

Further, the control condition of the security capability item may include a change of value of the corresponding security capability item actually applied to the communication between the UE and the network (i.e., changes of item value applied to the connection). That is, it means the case that the security information indicates a value different from a value applied to communication between the UE and the network for the security capability item, and thereby the value applied to the communication between the UE and the network is changed. In this case, if a security algorithm that is different from the security algorithm applied to the communication between the UE and the network for the security capability item set by the configuration of the security control is indicated by security information (that is, If the value applied to the communication between the networks is changed), the UE may perform an action on the corresponding security capability item.

The action of the UE determined in the configuration of security control may include an operation of accepting security information determined by the network, an operation of retransmitting the security capability (corresponding to the UE security preference according to the requirements of the user or application) of the UE to the network (or other network(s)), an operation of rejecting/disconnecting connection with the network.

The security capability item and its value are the same as the description of the configuration of security indication described above and will not be described below.

An example of a configuration of security control configured based on the above description is as follows.

Example 1: authentication method, (other than new NG authentication), (retry, reject)

When authentication method is other than newly specified ones in NG, it is rejected after retry.

Example 2: encryption algorithm, (any), (prefer maximum security available)

The preference to the strongest algorithm available is delivered to the system.

The action of the UE associated with the security control described above may be performed immediately after the security decision (i.e., when the UE receives the security information determined by the network), or may be performed by the UE when the value of the security capability item changes.

Alternatively, in a security set-up process (e.g., a security mode command procedure), the UE may transmit a value of a preferred security capability item to a network by including the value of the security capability item in the security capability, or may transmit a message defined separately from the capability.

Further, in an extended embodiment, when a UE is provided with a third party service other than the 3GPP system, the UE may deliver a value of a security capability item corresponding to the corresponding third party service to the system (i.e., network) when the corresponding service is started or while the corresponding service is being provided.

The above configuration of security indication and/or configuration of security control may be configured by the network and provisioned to the UE.

For example, as a method of provisioning to the UE, an OTA provisioning method may be used defined in 3GPP and OMA (Open Mobile Alliance). That is, the provisioning server may transmit a configuration of security indication and/or a configuration of security control to the UE.

Alternatively, the UE may download the configuration of security indication and/or the configuration of security control in a file through a connection with an internet or other device.

Further, the configuration of security indication and/or the configuration of security control may also be configured by the UE according to an input from a user.

In this case, as for the policy (i.e., the configuration of security indication and/or the configuration of security control) between the user and the system the user policy may always be assigned with a high priority, or the system policy may always be assigned with a high priority.

Alternatively, the policy (i.e., configuration of security indication and/or configuration of security control) priorities between the User and the System may be prioritized with specific principles or rules.

For example, a higher security policy of the User Policy or System Policy may always be assigned with a high priority.

As another example, the value provisioned on the network always has a high priority, while in specific cases or services the user configuration value may be assigned with a high priority.

Further, the configuration of security indication and/or the configuration of security control configured by the network may not be provisioned to the UE based on an operator policy. In this case, only the configuration of security indication and/or configuration of security control configured by the UE may be applied (e.g., where the user downloads from the menu or the file directly described in the above policy format, directly to the UE etc.). Accordingly, not only 3GPP system but also a third party service provider's security policy may be applied to a third party service.

The above-described indication policy (i.e., configuration of security indication) and control policy (i.e., configuration of security control) may operate in conjunction with or separately from each other. In addition, the policy format may be combined with the indication policy and the control policy. For example, it may be combined with security capability item/values (or action conditions)/actions (notification, control action), or it may be combined in a different manner.

The security negotiation procedure between the UE and the network proposed in the present invention will be described with reference to the following drawings based on the configuration of the security indication and/or security control of the UE.

For example, when the UE transmits an Attach Request message, an RRC Connection Request message, or the like to the network, the network and the UE may perform a procedure on a confirmation or negotiation of the security capability. In this case, negotiation may be performed between the UE and the network in the indication and/or control configuration proposed in the present invention.

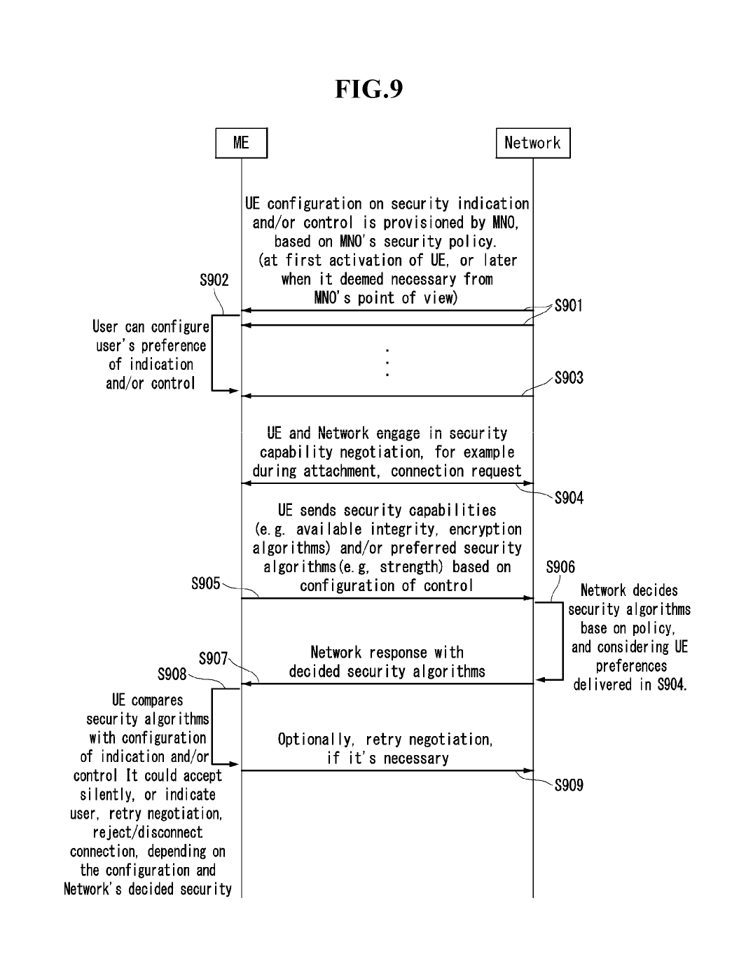

FIG. 9 is a diagram of illustrating a method of indicating and/or controlling a security in accordance with an embodiment of the present invention.

The configuration on the indication and/or control of security of the UE may be provisioned by a mobile network operator (MNO), based on the security policy of the MNO (S901).

The configuration on the indication and/or control of security of the UE may be transmitted to the UE when the UE is first activated, or thereafter it is considered to be necessary from the perspective of the MNO.

The UE may configure the indication and/or control of security preferred by the user according to the input received from the user (S902).

The UE and the network are engaged in the security capability negotiation (S903).

The step S903 is a precedent step for substantially performing a the security capability negotiation procedure in the subsequent step of S904 to S909, which may mean that an Attach procedure, a TAU procedure, an SMC procedure or the like between the UE and the network is initiated, or a RRC connection establishment procedure is initiated.

The UE may transmit to the network, the security capability (capabilities) (e.g. available encryption algorithm(s), available integrity protection(s), etc) and/or a preferred security algorithm(s) (i.e., encryption algorithm, integrity protection algorithm, e.g., strength of security algorithm or the like) based on the control configuration (S905).

For example, the UE may transmit the security capability (capabilities) to the network through the Attach Request message, TAU Request message or the like.

The network determines security information (e.g., security algorithm(s) (i.e., a value indicating the encryption algorithm, a value indicating the integrity protection algorithm) and a key length etc.) based on the security policy (S906).

In this case, if the preference of UE on the security algorithm (i.e., the encryption algorithm, the integrity protection algorithm) is received from the UE, then network may determine the security information based on the preference.

The network transmits the determined security information to the UE (S907).

For example, the network may transmit the security information to the UE through the Security Mode Command message, Attach Accept message, TAU Accept message or the like.

The UE may compare the configuration of the indication and/or control with the security information received from the network. In addition, the UE may determine whether the security information received from the network is to be accepted, or it is to be indicated/notified to the user, or negotiation with same network/other networks is to be retried (i.e. retransmitting the security capability of UE to the same network or transmitting the security capability of UE to other networks), or connection with the network is to be rejected/disconnected, based on the configuration of control and/or indication and the security information determined by the network (S908).

In this case, whether the security information received from the network is to be accepted or the negotiation is to be retried, or the connection with the network is to be rejected/disconnected, may be determined with the configuration of the security control.

In this case, whether it is to be indicated to the user (e.g. pop-up, full screen, status bar, icon, sound, or (LED: light emitting diode) indicator light), may be determined with the configuration of the security indication.

According to the above step of S908, if required, the UE may retry the negotiation (S909).

That is, the UE may retransmit the security capability and/or the preferred security algorithm to the same network or may transmit the security capability and/or preferred security algorithm to other networks, as shown in the above step of S905.

In this case, the network may reconfigure the security algorithm, the key length or the like, by considering the retransmitted security capability and/or preferred security algorithm, and may retransmit the security information including the reconfigured security algorithm, the key length or the like.

The subsequent procedure may be performed in accordance with steps S908 and S909 described above.

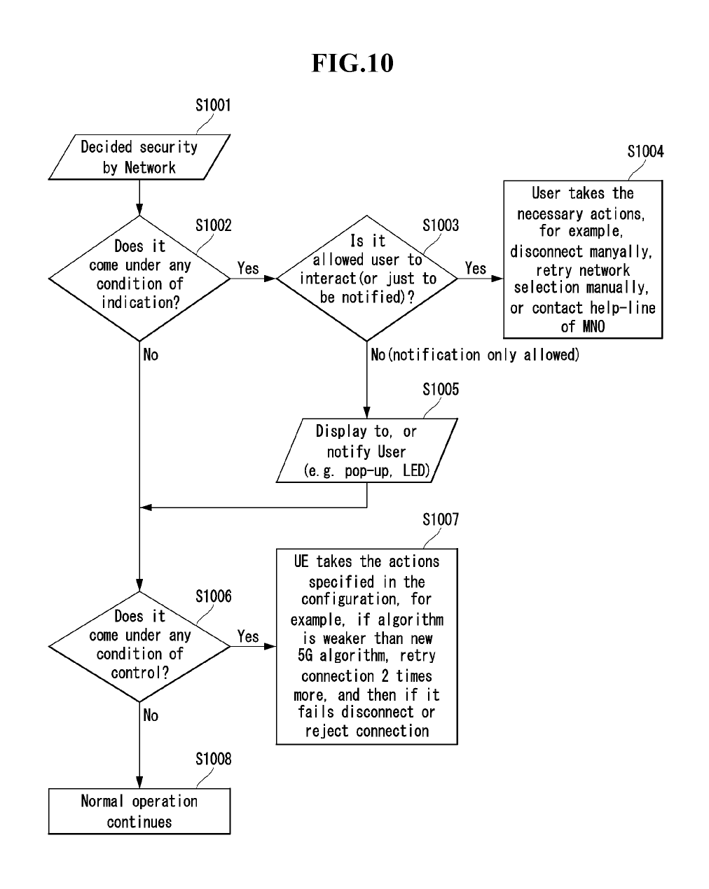

FIG. 10 illustrates a procedure for a UE security indication and control in accordance with an embodiment of the present invention.

Referring to FIG. 10, the security algorithm, the key length or the like, is determined by the network (S1001).

The UE having received the security information including the security algorithm, the key length or the like determined by the network, determines whether a condition of the security indication is satisfied or not, based on the received security information and the preconfigured configuration of security indication (S1002).

If the condition the condition of the security indication is satisfied, then it is determined whether an interaction from the user is permitted (or required), or a notification is only performed (S1003).

In this case, the UE may determine that the interaction from the user is permitted (or required), or the notification is only performed, based on the configuration of security indication.

If the interaction from the user is permitted (or required) in the step of S1003, then the UE receives a required action from the user with an input. For example, the user may manually select in disconnecting the connection with the network, may manually select in retrying the network selection, or may select a connection to the help-line of MNO.

Then, the UE may perform an operation according to the input (selection) from the user.

On the other hand, if the notification is only performed, then UE displays a security related message to the user (for example, using pop-up, LED or the like).

If the condition of the security indication is not satisfied in the step of S1002, then UE determines that the condition of the security control is satisfied based on the received security information and the preconfigured configuration of security control.

If the condition of the security control is satisfied in the step of S1006, then the UE performs the corresponding action within the configuration of security control (S1007).

For example, the UE may perform the following procedure. (For example, when the algorithm is weaker than the new 5G algorithm) UE may perform an operation up to twice on retransmitting the security capability of UE to the network, or transmitting the security capability of UE to other networks, and then if it fails, then the connection with the network may be disconnected/rejected.

If the condition of security control is not satisfied in the step of S1006, then the UE may perform a general operation (S1008).

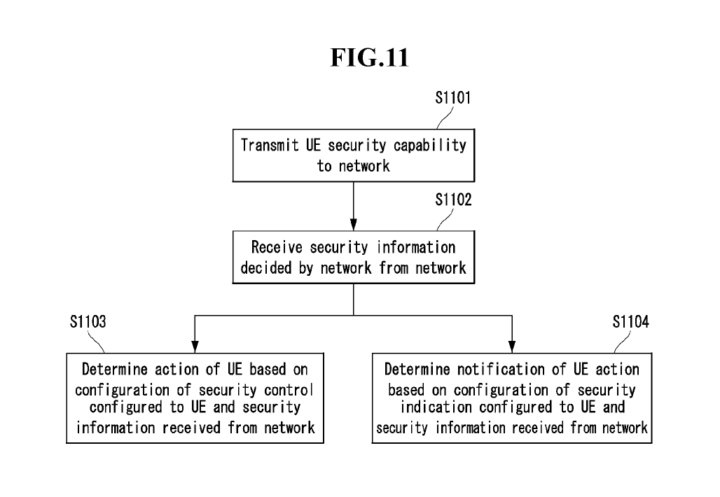

FIG. 11 illustrates a diagram of illustrating of an operation of UE for a UE security configuration in accordance with an embodiment of the present invention.

Referring to FIG. 11, the UE transmits the security capability of UE to the network (S1101).

The UE receives from the network, the security information (i.e., security algorithm, key length or the like) determined by the network (S1102).

The UE may determine the action of UE, based on the configuration of the security control configured in the UE and the security information received from the network (S1103).

Herein the configuration of the security control may include a control condition of the security capability item, the security capability item, an action of UE according to the control condition. In this case, the security capability item may include an authentication method, encryption algorithm, integrity algorithm or the like. In addition, the action may include an operation of accepting the security information determined by the network, an operation of retransmitting the security capability of UE to the network, an operation of disconnecting the connection with the network or the like.

If the control condition indicates one or more value of the security capability item, and when the security information received from the network indicates same value as the one or more values, then the action of UE may be performed.

Further, if the control condition indicates changes of the value of the security capability item, and when a value of the security capability item applied to communication between the UE and the network is changed depending on a value indicated by the security information, then the action of UE may be performed.

The UE may determine the notification of UE, based on the configuration of the security indication configured in the UE and the security information received from the network (S1104).

Herein, the configuration of the security indication may include the indication condition of the security capability item, and security capability item.

If the indication condition indicates one or more values of the security capability item, and when the security information received from the network indicates the same value as the one or more values, then the notification may be performed.

Further, if the indication condition indicates changes of the value of the security capability item, and when a value of the security capability item applied to communication between the UE and the network is changed depending on a value indicated by the security information, then the notification may be performed.

Such notification may be displayed on top of screen of UE, or may be displayed as a pop-up window or full screen until an explicit confirmation from the user, or may be displayed during a predetermined time. Or, it is also possible to reconfirm this information in a separate menu such as a setting menu.

The above mentioned configuration of the security control and/or configuration of the security indication may be provisioned to the UE and/or may be configured to the UE according to an input from a user and/or application/service. Or, the security requirement of the application may be set in the UE. In this case, the configuration of the security control and/or the configuration of the security indication may be set by the UE according to the requirements of the application.

That is, the configuration of the security control and/or the configuration of the security indication may be provisioned to the UE by the network, and/or is configured to the UE based on one or more among an input from a user, a requirement of application and application/service.

If the configuration of the security control/indication of the network is provisioned to the UE by the network, further the configuration of the security control/indication of the user is configured to the UE according to an input from the user, then the configuration of the security control/indication with high priority may be configured in the UE, among the configuration of the security control/indication of the network and the configuration of the security control/indication of the user.

The steps of S1103 and S1104 may be independently performed respectively, or may be performed in combination.

Device to which the Present Invention can be Applied

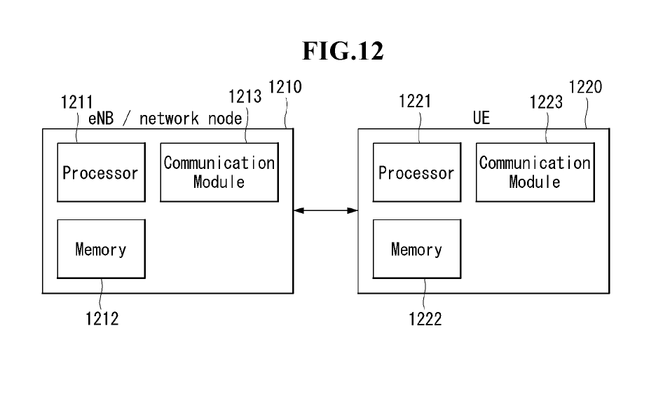

FIG. 12 is a block diagram illustrating a configuration of a communication device according to an exemplary embodiment of the present invention.

Referring to FIG. 12, a wireless communication system includes a network node 1210 and a plurality of UEs 1220.

The network node 1210 includes a processor 1211, a memory 1212, and a communication module 1213. The processor 1211 implements a function, a process and/or a method suggested in FIGS. 1 to 11. Layers of a wired/wireless interface protocol may be implemented by the processor 1211. The memory 1212 is connected to the processor 1211 to store various information for driving the processor 1211. The communication module 1213 is connected to the processor 1211 to transmit and/or receive a wired/wireless signal. The network node 1210 may be, for example, a base station, an MME, Particularly, when the network node 1210 is a base station, the communication module 1213 may include a radio frequency (RF) unit for transmitting/receiving a wireless signal.

The terminal 1220 (for example, UE) includes a processor 1221, a memory 1222, and a communication module (or RF unit) 1223. The processor 1221 implements a function, a process and/or a method suggested in FIGS. 1 to 11. Layers of a wireless interface protocol may be implemented by the processor 1221. The memory 1222 is connected to the processor 1221 to store various information for driving the processor 1221. The communication module 1223 is connected to the processor 1221 to transmit and/or receive a wireless signal.

The memories 1212 and 1222 may exist at the inside or the outside of the processors 1211 and 1221 and may be connected to the processors 1211 and 1221, respectively, by well-known various means. Further, the network node 1210 (a case of a base station) and/or the UE 1220 may have a single antenna or multiple antennas.

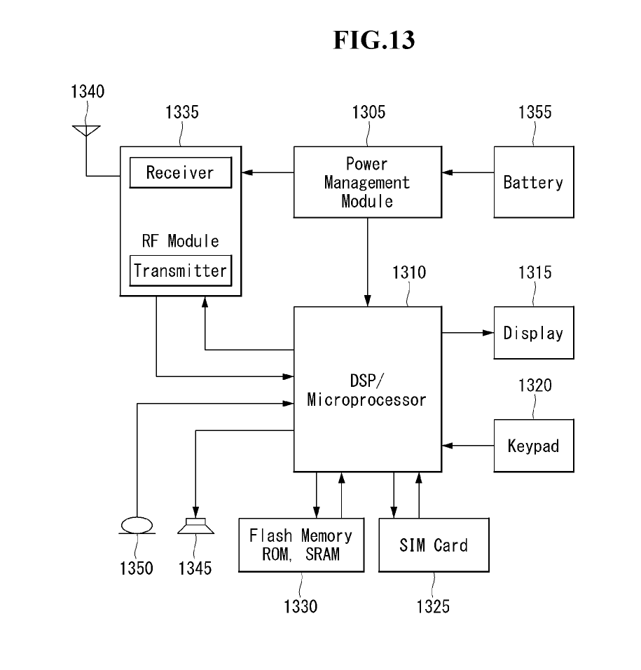

FIG. 13 is a block diagram illustrating a configuration of a communication device according to an exemplary embodiment of the present invention.

Particularly, FIG. 13 is a block diagram specifically illustrating the UE of FIG. 12.

Referring to FIG. 13, the UE may include a processor (or a digital signal processor (DSP)) 1310, a RF module (or RF unit) 1335, a power management module 1305, an antenna 1340, a battery 1355, a display 1315, a keypad 1320, a memory 1330, a Subscriber Identification Module (SIM) card 1325 (this element may be selected), a speaker 1345, and a microphone 1350. The UE may include a single antenna or multiple antennas.

The processor 1310 implements a function, a process and/or a method suggested in FIGS. 1 to 11. A layer of a wireless interface protocol may be implemented by the processor 1310.

The processor 1310 is connected to the processor 1310 and stores information related to operation of the processor 1310. The memory 1330 may exist at the inside or the outside of the processor 1310 and may be connected to the processor 1310 by well-known various means.

The user inputs, for example, instruction information such as a phone number by pressing (touching) a button of the keypad 1320 or by voice activation using the microphone 1350. The processor 1310 processes to perform an appropriate function such as reception of such instruction information and calling with a phone number. Operational data may be extracted from the SIM card 1325 or the memory 1330. Further, for user recognition and convenience, the processor 1310 may display instruction information or driving information on the display 1315.

The RF module 1335 is connected to the processor 1310 to transmit and/or receive an RF signal. In order to start communication, the processor 1310 transfers, for example, instruction information to the RF module 1335 in order to transmit a wireless signal constituting voice communication data. The RF module 1335 is configured with a receiver and a transmitter in order to receive and transmit a wireless signal. The antenna 1340 performs a function of transmitting and receiving a wireless signal. When receiving a wireless signal, the RF module 1335 may transfer a signal in order to process by the processor 1310 and may convert a signal with a base band. The processed signal may be converted to audible or readable information output through the speaker 1345.

In the foregoing exemplary embodiments, constituent elements and characteristics of the present invention are combined in a predetermined form. Unless phrases explicitly represent, it should be considered that each constituent element or characteristic is selective. Each constituent element or characteristic may be executed in a form that does not combined with other constituent elements or characteristics. Further, by combining some configurations and/or characteristics, an exemplary embodiment of the present invention may be configured. The order of operations described in exemplary embodiments of the present invention may be changed. Some configurations or characteristics of any exemplary embodiment may be included in another exemplary embodiment or may be replaced with a configuration or a characteristic corresponding to another exemplary embodiment. It will become apparent that claims that are not in an explicit cited relation in the claims may configure an exemplary embodiment by combination and may be included in new claim by amendment after filing.

An exemplary embodiment of the present invention may be implemented by various means, for example, hardware, firmware, software, or combinations thereof. When implementing by hardware, an exemplary embodiment of the present invention may be implemented by at least one application specific integrated circuits (ASICs), digital signal processors (DSPs), digital signal processing devices (DSPDs), programmable logic devices (PLDs), field programmable gate arrays (FPGAs), a processor, a controller, a microcontroller, and a microprocessor.

When implementing by firmware or software, an exemplary embodiment of the present invention may be implemented in a form of a module, procedure, and function that perform the foregoing function or operation. A software code may be stored at a memory to be driven by a processor. The memory may be located at the inside or the outside of the processor and may transmit and receive data to and from the processor by already known various means.

It will become apparent to a person of ordinary skill in the art that the present invention may be embodied in different specific forms without deviating from essential features of the present invention. Therefore, it should be considered that the detailed description is not to limit the present invention but to illustrate it. Thus, it is intended that the present invention cover the modifications and variations of this invention provided they come within the scope of the appended claims and their equivalents.

An exemplary embodiment of the present invention mainly describes an example applied to a 3GPP LTE/LTE-A system or 5G system, but can be applied to various wireless communication systems other than the 3GPP LTE/LTE-A system.

What is claimed is:

1. A method of performing a security configuration by a UE (User Equipment) in a wireless communication system, the method comprising steps of:
transmitting a security capability of the UE to a network;
receiving security information determined by the network from the network; and
determining an action of the UE, based on a configuration of a security control configured in the UE and the security information received from the network, and
wherein the configuration of the security control includes a security capability item, a control condition of the security capability item, and the action of the UE according to the control condition.

2. The method of claim 1, wherein the security capability item includes an authentication method, an encryption algorithm, and an integrity algorithm.

3. The method of claim 2, wherein if the control condition indicates one or more values of the security capability item,
when the security information indicates the one or more values of the security capability item, the action of the UE is performed.

4. The method of claim 2, if the control condition indicates a change of value of the security capability item, and
when a value of the security capability item applied to communication between the UE and the network is changed depending on a value indicated by the security information, the action of the UE is performed.

5. The method of claim 2,
wherein the action includes an action of accepting the security information received from the network, an action of retransmitting the security capability of the UE to the network, and an action of disconnecting a connection with the network.

6. The method of claim 1,
wherein the configuration of the security control is provisioned to the UE by the network, and/or is configured to the UE based on one or more among an input from a user, a requirement of application and application/service.

7. The method of claim 1,
wherein when the configuration of the security control of the network is provisioned to the UE by the network, and the configuration of the security control of the user is configured by the UE,
a configuration of the security control with a high priority is configured by the UE, among the configuration of the security control of the network and the configuration of the security control of the user.

8. The method of claim 1,
wherein whether the security information received from the network is notified of the user, is determined based on the configuration of the security indication configured in the UE and the security information received from the network, and
the configuration of the security indication includes an security capability item, an indication condition of the security capability item.

9. The method of claim 8,
wherein if the indication condition indicates one or more values of the security capability item,
when the security information indicates the one or more values of the security capability item, the notification is performed.

10. The method of claim 8,
wherein if the indication condition indicates a change of the value of the security capability item, and
when a value of the security capability item applied to communication between the UE and the network is changed depending on a value indicated by the security information, the notification is performed.

11. The method of claim 8,
wherein the notification is displayed in a top of a screen of the UE, displayed until an explicit confirmation is inputted from a user, or displayed during a predetermined time.

12. A UE (User Equipment) for performing a security configuration in a wireless communication system, comprising:
a radio frequency (RF) unit for transmitting and receiving a wireless signal; and
a processor for controlling the RF unit, and
wherein the processor configured to:
transmit a security capability of the UE to a network;
receive security information determined by the network from the network; and
determine an action of the UE, based on a configuration of a security control configured in the UE and the security information received from the network, and
wherein the configuration of the security control includes a security capability item, a control condition of the security capability item, and the action of the UE in accordance with the control condition.
